(19) United States
(12) Patent Application Publication
(10) Pub. No.: US 2012/0234753 A1
(43) Pub. Date: Sep. 20, 2012

(54) COOLING SYSTEM AND METHOD FOR THE OPERATION THEREOF

(76) Inventors: Marc Alexander Flettner, Duesseldorf (DE); Juergen Scheen, Dortmund (DE)

(21) Appl. No.: 13/501,710

(22) PCT Filed: Apr. 21, 2011
(86) PCT No.: PCT/EP2010/006307

§ 371 Date: May 22, 2012

(30) Foreign Application Priority Data
Oct. 16, 2009 (DE) 10 2009 049 831.1

(51) Int. Cl. C02F 9/14; C02F 101/10

(52) U.S. Cl. 210/615; 210/151

(57) ABSTRACT

The invention relates to a cooling method and cooling system comprising a cooling device (1), in particular a cooling tower (1), for cooling cooling water and at least one consumer (4) to be cooled, wherein the cooling device (1) and the at least one consumer (4) are arranged in a cooling water circuit (1, 2, 3, 4), a filter (11) having immobilized microorganisms, in particular having a microorganism colony, being arranged in the cooling water circuit (1, 2, 3, 4) between the at least one consumer (4) and the cooling device (1) or in a separate circuit (1, 9, 10, 11, 12) connected thereto, in order to specifically filter out nutrients from the cooling water by means of metabolizing and/or storing the nutrients by the microorganisms in the filter (11), wherein the immobilized microorganisms are inoculated and cultivated outside the circuit with autochthonous and/or allochthonous microorganisms from the cooling system and are integrated into the cooling system as a functionally ready collection of microorganisms and wherein, in the cooling water circuit (1, 9, 10, 11, 12), in particular downstream of the filter (11), a water treatment device (9) is arranged, which has the property of adding zinc to the cooling water, in particular in order to convert calcite occurring in the cooling water into aragonite and/or vaterite and/or other crystallization forms.

The invention relates to a cooling system comprising a cooler for the cooling of cooling water and at least one consumer to be cooled, where the cooler and the consumer are provided in a cooling-water circuit. The invention also relates to a method of operating a cooling system comprising a cooling-water circuit in which cooling water circulates and is warmed in at least one consumer and cooled in a cooler.

Cooling systems with such a cooling-water circuit are known from the prior art and are often used to cool consumers of all kinds, for example at least one heat exchanger for cooling at least one further circuit or for transmitting heat from at least one further circuit to the cooling-water circuit. For example, cooling towers, in which the cooling water is sprayed and therefore cooled and recovered due to the evaporation effect, can be used as a possible cooler.

Both when using cooling towers as the cooler and also with other alternative coolers, it is known to withdraw some of the circulating cooling water and replace it with fresh cooling water. Particularly in the case of devices and methods with cooling towers, the amount of water that evaporates must also be replaced by feed water.

With cooling systems of this type disclosed in the prior art, a known problem is that, when cooling towers are used as the cooler, the circulating water contains both bacteria and nutrients that, for example, are fed in externally, for example by using atmospheric ambient air, that can become contaminated, in the cooling towers. With the cooling systems disclosed in the prior art, bacteria films that adversely affect the operation of the cooling system can therefore form within the cooling-water circuit and the associated system parts. Cooling water vapor or aerosol can also strongly contribute to contamination of the air, for example due to legionella or other pathogenic microorganisms.

It is therefore disclosed in the prior art to treat the cooling water circulating in the cooling system and if necessary also the cooling water added in the form of fresh water in order to prevent bacterial growth in the cooling system. For this purpose, on the one hand, filtration stages are used in order to remove or at least reduce possible contamination of the starting water, and in addition injection techniques in order to add toxins, in is particular biocides that counteract microorganisms, to the circulating water or water to be added.

Such measures can lead to highly toxic cooling water so that handling the cooling water of a cooling system must be classed as a hazard and cooling water of this kind must also be disposed of in a particular manner.

As well as treating the cooling water with regard to such microbiological aspects, the cooling water is also treated in order to prevent corrosion in the cooling water pipes. For example, it is known to soften cooling water, i.e. remove hardness components such as lime from the water, in order to prevent deposits within the cooling circuit. Such measures are also cost and maintenance intensive due to the softener resins used and the waste-water-intensive regeneration necessary for this.

Cooling systems of this described conventional type are therefore highly environmentally polluting systems.

It is therefore the object of the invention to provide a cooling system and a method of operating a cooling system of the kind described in the introduction that have high environmental compatibility and can be manufactured and operated in a structurally simple and maintenance-friendly manner.

According to the invention, the object is achieved in that, for a cooling system of the kind described, a filter with immobilized microorganisms, for example in the form of a microorganism colony, is provided in the cooling-water circuit between consumer and cooler or in a separate circuit connected thereto in order to specifically filter out nutrients from the cooling water by metabolization and/or storage of the nutrients by the microorganisms in the filter, the immobilized microorganisms being inoculated and cultivated outside the circuit with autochthonous and/or allochthonous microorganisms from the cooling system and integrated into the cooling system as a functionally ready collection of microorganisms, and wherein a water-treatment device that can add zinc to the cooling water, in particular in order to convert calcites occurring in the cooling water into aragonites and/or vaterites and/or other crystallization forms, is provided in the cooling-water circuit, in particular downstream of the filter.

Regarding the method aspect, the object is achieved in that the cooling water in the cooling-water circuit is fed through a filter that has immobilized microorganisms, for example a microorganism colony, for example in the form of a locally concentrated collection of bacteria, between consumer and cooler or in a separate circuit connected thereto, the immobilized microorganisms being inoculated and cultivated outside the circuit with autochthonous and/or allochthonous microorganisms from the cooling system and are integrated into the cooling system as a functionally ready collection of microorganisms, and the nutrients carried in the cooling water being metabolized and/or stored in the filter and therefore at a locally concentrated point within the circuit by the microorganisms, and wherein a water-treatment device that adds zinc to the cooling water, in particular that converts calcites in the cooling water into aragonites and/or vaterites and/or other crystallization forms, is provided in the cooling-water circuit, in particular downstream of the filter.

Instead of the previous chemical combating of possible bacteria growth within a cooling system, the core idea of the invention is based on the consideration of removing the basis of existence of the bacteria freely occurring in a cooling system by nutrient deprivation.

According to the invention, this is specifically achieved in that a special filter stage is provided within the cooling system, in which locally concentrated immobilized microorganisms, for example a microorganism colony that consumes the nutrients occurring in the water by metabolization, is resident. At the same time, “immobilized microorganisms” is preferably understood to mean that these particularly largely remain in situ, in particular therefore are largely unable to leave the filter.

Other microorganisms that occur at other places within the cooling system accordingly encounter no nutrition or insufficient nutrition to survive and to be able to form a microorganism film/biofilm in the system that interferes with operation of the system.

Accordingly, due to the highly concentrated collection of microorganisms, such as bacteria for example, within the filter stage, according to the invention all occurrences of nutrients within this filter stage are preferentially and largely consumed or are reduced to such an extent that, even when bacteria films have already developed in the system, after a filter according to the is invention is added to the cooling system these already formed biofilms starve and die.

The microorganisms/bacteria can only survive within the filter to which the microorganisms have been added, as here they are provided with sufficient nutrients from the cooling water in the circuit, where, due to their high number of microorganisms compared with the free organisms in the remaining circuit, the microorganisms within the filter survive, for example as a colony, even when there is a potential dearth of nutrients, whereas smaller bacterial strains in the free system die off.

According to the invention, the microorganisms that are used in the filter comprise autochthonous and/or allochthonous microorganisms, in particular bacteria. Autochthonous microorganisms are understood to be microorganisms that occur in the cooling system in any case, in particular that occur upstream of the filter when the microorganism colony according to the invention is integrated into the cooling system.

At the same time, according to the invention, a microorganism colony for the filter according to the invention is inoculated and cultivated outside the circuit with autochthonous and/or allochthonous microorganisms from the cooling system and then integrated into the cooling system or the cooling system filter as a functionally ready collection of microorganisms, for example in the form of a colony, for example after a required minimum size (minimum number of microorganisms) is exceeded.

It is therefore also possible to provide existing cooling systems with such a biological filter, namely in that a sample of the circulating cooling water is taken and used to inoculate a substrate for the development of microorganisms. The development of the microorganisms can be carried out specifically in accordance with a water analysis of the water sample in order to determine the necessary conditions that are required to permanently eliminate the nutrients and already existing microorganisms occurring in the cooling water.

Here, use can essentially be made of a substrate that is preferentially colonized by microorganisms, in particular preferentially colonized compared with other system parts, in order to achieve and maintain a rapid and sustained concentration of microorganisms within the filter compared with other system parts.

According to the invention, when immobilized microorganisms that have already been produced are integrated into the circuit as a filter, it can further preferably be provided that the microorganisms are provided on a substrate, the colonization surface of which is larger than the functionally similar surface of the remaining system parts through which the cooling water flows.

It is therefore possible here, for example, to calculate the size of this surface of the system areas and to select an amount of substrate that provides a larger surface area. For example, highly porous, in particular inert, for example ceramic, substrates that can provide surface areas in the order of magnitude of 200 to more than 400 square meters surface area per liter of substrate or even more can be used here. There is therefore a very good possibility of providing a very large colonization area for microorganisms in a colony within the filter according to the invention on a comparatively small volume in order to provide an extremely large competitive surface for the colonization of microorganisms compared with the remaining system parts. Overall, the number of microorganisms can preferably be made larger than in the remaining parts of the system.

As, particularly in the case of cooling tower applications, nutrients, such as organic waste or even bird droppings for example, are drawn into the system by the atmospheric air used, use is preferably made of microorganisms that comprise bacteria strains that preferably metabolize and/or store nitrogen compounds.

For example, use can be made of such bacteria strains of the nitrosomona or nitrobacter type that metabolize/store general nitrogen compounds such as ammonium or ammonia to nitrite and, on the other hand, metabolize/store nitrite to nitrate. To prevent too high a nitrate enrichment within the cooling circuit, bacteria that feed on nitrate and that work in an anaerobic manner can be used in the colony or in the filter or also separately therefrom. Such bacteria that feed on nitrate and that work in an anaerobic manner can be used, for example, in a separate filter subsequent to the above-mentioned filter in a bypass of the cooling-water circuit, for example with a lower cooling-water flow speed compared with the above-mentioned filter.

According to the invention, a water-treatment device that adds zinc to the cooling water is also provided in the cooling circuit, in particular downstream of said filter according to the invention, with the microorganisms. This enables calcites occurring in the cooling water to be converted into aragonites and/or vaterites and/or other crystallization forms.

By way of example, use can be made here of an arrangement that, using a sacrificial zinc anode working on the galvanic principle, emits zinc ions into the water and therefore effects a zinc enrichment that on the one hand acts in a corrosion-inhibiting manner in the water pipes of the cooling system and therefore achieves a first advantage and, on the other, due to the addition of zinc, converts calcites into the aragonites and/or vaterites and/or other crystallization forms and constitutes a second advantage. Compared with calcites, these aragonites or vaterites or other crystallization forms have the particular advantage that they are deposited to a lesser extent on system parts, i.e. preferably remain in suspension in the water, in particular therefore are carried through the system piping and parts of the system through which water flows in the form of abrasive particles. The abrasion achieves the advantage that any already existing bacteria films are permanently eroded, as are any already existing lime deposits that may be present.

Accordingly, the invention has the advantage that classical softening systems for original water conditioning disclosed in the prior art can be dispensed with, particularly as here, according to the invention, the hardness components occurring in the water are used with positive effect. In a further embodiment, aragonites/vaterites or other crystallization forms can also be filtered out by a membrane filter system, in particular the filter pores thereof are oriented towards the mean size of the aragonite/vaterite particles produced by the water-treatment device. This enables mechanical softening to be carried out.

By way of example, the size distribution of the aragonite or vaterite particles in the cooling water produced by the use of the zinc water-treatment device can be determined by measurement. Such measurement can also be carried out by the manufacturer independently of the specific cooling water application and associated with the specific water-treatment device or a whole range. A membrane filter system whose filter pores are smaller than the most frequent particle size measured in the distribution, can then be chosen based on the measured size distribution.

As well as the two advantages previously mentioned, zinc present in the cooling water has the effect of inhibiting the growth of new bacteria biofilms. Although in conjunction with the above-mentioned filter containing microorganisms, the use of zinc initially appears counterproductive, here however it has the particular synergetic advantage that
1. The formation of a bacteria biofilm outside the filter containing microorganisms is inhibited and bacteria remain free in the water,
2. Bacteria biofilms already present outside the filter are reduced due to the competition for nutrients by the microorganisms in the filter and due to the lack of nutrients produced thereby as well as by the inhibiting action of the zinc in the free water,
3. The microorganisms remaining freely in the water pass into the filter in the cooling water flow and are trapped there,
4. The zinc in the comparatively large collection of microorganisms in the filter has no effective negative impact with regard to colony reduction.

Particularly when an addition of zinc to the cooling-water circuit is used, it can be provided that, when cultivating immobilized bacteria outside the circuit for later addition of the bacteria to a filter within the circuit, these bacteria are already cultivated under the action of zinc so that this bacterial culture has a higher resistance to zinc and has a higher survival rate in a water circuit to which zinc has been added than the bacteria that are present in the cooling water.

When cultivation is carried out, for example, in a water circuit provided for cultivation, use can be made of a zinc water-treatment device of the same kind as used in the cooling system.

A zinc concentration in the cultivation water that is higher than the later zinc concentration in the cooling water can also be deliberately chosen for the cultivation. The bacteria in a filter that is to be used in the cooling-water circuit are therefore accustomed to correspondingly higher zinc concentrations and can withstand the comparatively lower zinc concentration in the cooling water without any problems, whereas the growth of bacteria originally present in the cooling water or the system is inhibited by the influence of zinc.

If the addition of zinc should have such a high concentration in the cooling water that the microorganism colony in the filter is also gradually depleted, then the filter or the colony contained therein can be replaced by a new colony cultivated outside the circuit, for example regularly after a predetermined time interval.

The filter can also be replaced or cleaned, for example by back-washing, for the purpose of removing depletion products.

Compared with the systems disclosed in the prior art, the invention therefore has the overall advantage that the chemical use of agents for combating bacteria can be substantially or completely dispensed with, as, according to the invention, the negative effect of bacteria in the cooling circuit of cooling systems that has been feared up to now in the prior art is reversed in order to specifically use the bacteria present in the circuit in an increased concentration, i.e. a concentration that is higher in comparison with the free water areas of the cooling circuit, in order to effect a strong consumption of nutrients and/or a storage of nutrients in such a collection of bacteria or other microorganisms so that any bacteria present in the remaining parts of the system outside this filter according to the invention encounter no nutrients of any kind or at least considerably fewer nutrients and die.

In an improvement, it can also be provided that a water-treatment device, by means of which the water flowing through this water-treatment device can be/is treated with UV light, in particular UV-C light (in particular 254 nm), is provided in the is cooling-water circuit between the consumer and the cooler or in a separate circuit connected thereto and/or in a feed pipe for topping-up water. Particularly preferably, such a UV water-treatment device can be connected upstream of the filter with the immobilized microorganisms in the direction of flow.

This achieves the advantage that the microorganisms that are lysed and destroyed by the UV radiation, in particular UV-C radiation, or other substances that can be destroyed with UV light and that are free in the water cannot be used as nutrition for other microorganisms or biofilms at another point in the system. Furthermore, the positioning of this UV water-treatment device upstream of a filter with the microorganism colony causes the destruction products of this UV water-treatment device to be immediately filtered out of the water circuit, in particular immediately further depleted by the immobilized microorganisms at the required point in the filter.

An embodiment according to the invention is described in the following FIGURE.

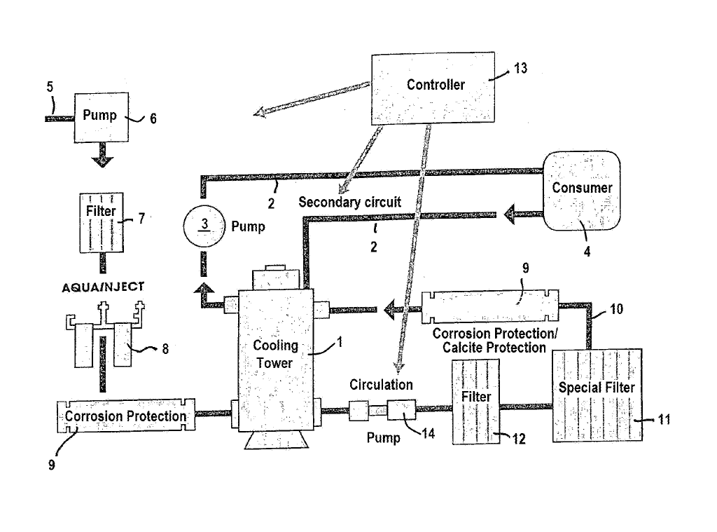

FIG. 1 shows a water circuit in a cooling system with a cooling tower 1 as the cooler with a circuit starting at the cooling tower 1 and having a water pipe 2 for circulating water through a consumer 4, for example a heat exchanger, by the action of a circulating pump 3, the water being fed back to the cooling tower via the pipe 2.

Cooling of the water can take place in the cooling tower by spraying and feeding in air in a known manner, and the water can also be desludged there although this is not shown here. Furthermore, an external water supply 5, for example by a pump 6 that is followed by a filter 7 for removing coarse or suspended particles from the water to be fed in, for example, is also shown. Further secondary treatment of the water can take place in a treatment device 8, for example also by injecting treatment agents, after which, in this embodiment shown here, a physical treatment, in which zinc ions are fed into the water on the galvanic principle by a sacrificial zinc anode, is provided in a treatment device 9. Here, this water can then be added to the water circuit at the cooling tower via the cooling water pipe 2, for example to compensate for water lost during purification or to evaporation.

The system parts described above substantially constitute devices and measures known from the prior art.

The parts of the system shown here that are critical to the invention results from the further water circulation through the pipe circuit 10 that can also be operated by a pump. The two circuits in the pipes 2 and 10 described go through the cooler, for example the cooling tower, or have this as a common component.

In this circuit through the water pipe 10, the first important feature according to the invention is the filter 11 in which, according to the invention, substrate-bound immobilized bacteria for example, are provided, possibly from a plurality of different bacteria strains that are provided and are suitable for metabolizing and/or storing nutrients within the cooling water that would otherwise make substantially the same bacteria in the free water of the cooling circuit or at certain parts of the system available for colonization and survival. Here, the filter function is therefore substantially based on removing the nutrients and therefore the basis of existence from bacteria in the parts of the system outside the filter so that the cooling system can work substantially free of biofilms outside the filter.

If necessary, existing light biofilms can be combated by biocidally or biostatically acting agents that are added to the cooling circuit. Such agents can be dosed in such a way that they are sufficient to combat light microbiological film portions in the remaining parts of the system to a sufficient extent, where however the dosing is not sufficient to permanently endanger the plentiful bacteria collection of the filter 11.

If necessary, when carrying out the method of the invention, a possibly self-consuming bacteria colony, in particular a consumption brought about by the dying of microorganisms, can specifically be used to guarantee a permanent freedom from biofilms within the remaining system parts and then, after the bacteria have been consumed, to replace these bacteria by new bacteria, in particular immobilized bacteria that have been cultivated externally.

In an embodiment, it can also be provided that, in the event of excess bacterial growth, bacteria strains that are released from the filter 11 are filtered out afterward, enabling the size of a bacteria colony to also be substantially kept constant in this embodiment. In particular, according to the invention, a certain size of bacteria colony with regard to the number of microorganisms that results from the nutrients available within the cooling-water circuit will establish itself.

Furthermore, the embodiment in FIG. 1 also shows a preferred embodiment in which a water-treatment device 9 that substantially corresponds to that described in the introduction for feeding in water via the pipe 5, namely here with the principle of adding zinc to the cooling water by galvanic action in conjunction with a sacrificial zinc anode, is incorporated downstream of the filter 11.

This then leads to a conversion of calcites into aragonites and/or vaterites and/or other crystallization forms that remain and/or act abrasively in the cooling water substantially in suspension so that already existing microbiological films and also other deposits within the system parts through which the cooling water flows can be mechanically eroded and removed. These fractions that possibly collect in the sump of a cooling tower, can be deposited or also filtered out by a filter stage, for example a filter 12 upstream of the microbiologically acting filter 11.

In addition, aragonites/vaterites or other crystallization forms held in suspension also have an advantage in that they can form a colonization area for free bacteria within the cooling water so that any bacteria are deposited here and are either filtered out with the aragonites/vaterites or other crystallization forms by the filter 12 or are carried into the biologically acting filter 11.

Furthermore, a controller 13 can also be provided here, for example to control or regulate the pumps and therefore the water circuits as a function of measured parameters. Specific purification and addition of fresh water can also be carried out by this controller.

1. A cooling system comprising a cooler, for cooling water and at least one consumer to be cooled, wherein the cooler and the consumer are provided in a cooling-water circuit, wherein
a filter with an immobilized microorganism colony is provided in the cooling-water circuit between the consumer and the cooler or in a separate circuit connected thereto in order to specifically filter out nutrients from the cooling water by metabolization or storage of the nutrients by the microorganisms in the filter,
the immobilized microorganisms are inoculated and cultivated outside the circuit with autochthonous or allochthonous microorganisms from the cooling system and integrated into the cooling system as a functionally ready collection of microorganisms, and
a water-treatment device that can add zinc to the cooling water, in particular in order to convert calcites occurring in the cooling water into aragonites and/or vaterites and/or other crystallization forms, is provided in the cooling-water circuit, in particular downstream of the filter.

2. The cooling system as claimed in claim 1, wherein the microorganisms are provided, in particular fixed, on a substrate having a colonization surface that is chemically inert or the surface or arrangement of which is larger than the surface of the remaining system parts through which the cooling water flows.

3. The cooling system as claimed in claim 1, wherein the number of microorganisms is made larger than in the remaining part of the system.

4. The cooling system as claimed in claim 1, wherein a water-treatment device, by means of which the water flowing through the water-treatment device can be/is treated with UV-C light, is provided in the cooling-water circuit between the consumer and the cooler or in a separate circuit connected thereto.

5. The cooling system as claimed in claim 4, wherein the UV water-treatment device is connected upstream of the filter with the immobilized microorganisms in the direction of flow.

6. A method of operating a cooling system comprising a water circuit in which cooling water circulates and is warmed by at least one consumer and cooled in a cooler, wherein
the cooling water in the cooling-water circuit is fed through a filter that comprises an immobilized microorganism colony between the consumer and the cooler or in a separate circuit connected thereto,
the immobilized microorganisms are inoculated and cultivated outside the circuit with autochthonous or allochthonous microorganisms from the cooling system and are integrated into the cooling system as a functionally ready collection of microorganisms, and the nutrients carried in the cooling water are metabolized or stored in the filter by the microorganisms, and
is a water-treatment device that adds zinc to the cooling water to convert calcites in the cooling water into aragonites or vaterites or other crystalline forms, is provided in the cooling-water circuit downstream of the filter.

7. The method as claimed in claim 6, wherein bacterial films already existing in the cooling-water circuit of the cooling system are mechanically eroded by adding zinc to the cooling water such that calcites present in the cooling water are converted into aragonites or vaterites that predominantly remain in suspension and act abrasively.

8. The method as claimed in one of the preceding claim 6, wherein the microorganisms are cultivated outside the circuit under the influence of zinc in order to increase the resistance of the microorganisms to zinc.

9. The method as claimed in claim 6, wherein zinc or halogens are added to the feed water to reduce the number of germs in the feed water.

10. The method as claimed in claim 9, wherein the addition is carried out in a dosing that does not affect the immobilized microorganisms.

11. The method as claimed in claim 6, wherein, in the cooling-water circuit between the consumer and the cooler or in a separate circuit connected thereto, the water flowing through a water-treatment device is treated with UV-C light by the water-treatment device.

12. The method as claimed in claim 11, wherein the UV light treatment takes place upstream of the filter with the immobilized microorganisms in the direction of flow.
